(19) United States
(12) Patent Application Publication
(10) Pub. No.: US 2017/0357784 A1
(43) Pub. Date: Dec. 14, 2017

(54) METHOD AND SYSTEM FOR LICENSE MANAGEMENT

(71) Applicant: Arista Networks, Inc., Santa Clara, CA (US)

(72) Inventors: Kenneth James Duda, Santa Clara, CA (US); Ethan Barnett Rahn, Los Angeles, CA (US); Nathan Boyd Kitchen, San Francisco, CA (US); Kenneth John Carpenter, Vancouver (CA); Karan Jayesh Bavishi, Bangalore, Karnataka (IN)

(73) Assignee: Arista Networks, Inc., Santa Clara, CA (US)

(21) Appl. No.: 15/497,431

(22) Filed: Apr. 26, 2017

(30) Foreign Application Priority Data
Jun. 14, 2016 (IN) 201641020249

(51) Int. Cl. G06F 21/10

(52) U.S. Cl. CPC G06F 21/105; G06Q 2220/18

(57) ABSTRACT

A method for license management. The method includes making a first determination by a local license server of a coordination point that a feature license that is not available on the local license server is required by the local license server. The method further includes, based on the first determination: sending, by the coordination point, a license availability request to an auto activation server, receiving, by the coordination point and from the auto activation server, information about available feature licenses, and sending, by the local license server of the coordination point to a central license manager, an activation request specifying the feature license. The specified feature license is one of the available feature licenses. The method further includes, in response to sending the activation request: receiving, by the local license server from the central license manager, an activated feature license.

### CROSS-REFERENCE TO RELATED APPLICATIONS

This non-provisional patent application claims priority to Indian Patent Application No. 201641020249, filed on Jun. 14, 2016 in the Indian Intellectual Property Office, under 35 U.S.C. §119(a). Indian Patent Application No. 201641020249 is incorporated herein by reference in its entirety.

### BACKGROUND

Users of a software and/or hardware features may be required to purchase a license in order to activate the software and/or hardware features. License management may be used to enforce proper licensing.

### SUMMARY

In general, in one aspect, the invention relates to a method for license management. The method includes making a first determination by a local license server of a coordination point that a feature license that is not available on the local license server is required by the local license server. The method further includes, based on the first determination: sending, by the coordination point, a license availability request to an auto activation server, receiving, by the coordination point and from the auto activation server, information about available feature licenses, and sending, by the local license server of the coordination point to a central license manager, an activation request specifying the feature license. The specified feature license is one of the available feature licenses. The method further includes, in response to sending the activation request: receiving, by the local license server from the central license manager, an activated feature license.

In general, in one aspect, the invention relates to a method for license management. The method includes receiving, by an auto activation server, a license availability request from a coordination point, and determining available feature licenses, in response to the license availability request. Determining the available feature licenses includes querying, by the auto activation server, a central license manager for available feature licenses, receiving, from the central license manager, information specifying available feature licenses and corresponding activation IDs, and sending, by the auto activation server, the information specifying the available feature licenses and corresponding activation IDs to the coordination point.

In general, in one aspect, the invention relates to a system for license management. The system includes a coordination point, a central license manager, and an auto activation server. The coordination point includes a local license server. The coordination point is configured to make a first determination, by the local license server, that a feature license that is not available on the local license server is required by the local license server, and based on the first determination, send a license availability request to the auto activation server, receive, from the auto activation server, information about available feature licenses, and send, by the local license server to the central license manager, an activation request specifying the feature license. The specified feature license is one of the available feature licenses. The coordination point is further configured to, in response to sending the activation request receive, by the local license server from the central license manager, an activated feature license.

In general, in one aspect, the invention relates to a system for license management. The system includes a coordination point, a central license manager, and an auto activation server. The coordination point includes a local license server. The auto activation server is configured to receive a license availability request from a coordination point, and determine available feature licenses, in response to the license availability request. Determining the available feature licenses includes querying the central license manager for available feature licenses, receiving, from the central license manager, information specifying available feature licenses and corresponding activation IDs, and sending the information specifying the available feature licenses and corresponding activation IDs to the coordination point.

In general, in one aspect, the invention relates to a non-transitory computer readable medium that includes instructions that enable a coordination point to make a first determination by a local license server of the coordination point that a feature license that is not available on the local license server is required by the local license server, and based on the first determination, send a license availability request to an auto activation server, receive from the auto activation server, information about of available feature licenses, and send, by the local license server of the coordination point to a central license manager, an activation request specifying the feature license. The specified feature license is one of the available feature licenses. The instructions further enable the coordination point to, in response to sending the activation request, receive, by the local license server from the central license manager, an activated feature license.

In general, in one aspect, the invention relates to a non-transitory computer readable medium that includes instructions that enable an auto activation server to receive a license availability request from a coordination point, and determine available feature licenses, in response to the license availability request, including querying a central license manager for available feature licenses, receiving, from the central license manager, information specifying available feature licenses and corresponding activation IDs, and sending the information specifying the available feature licenses and corresponding activation IDs to the coordination point.

### BRIEF DESCRIPTION OF DRAWINGS

FIG. 1 shows a system, in accordance with one or more embodiments of the invention.

FIG. 2 shows an entitlement and a corresponding activation identifier (ID), in accordance with one or more embodiments of the invention.

FIGS. 3-6 show flowcharts in accordance with one or more embodiments of the invention.

FIG. 7 shows a computing system in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

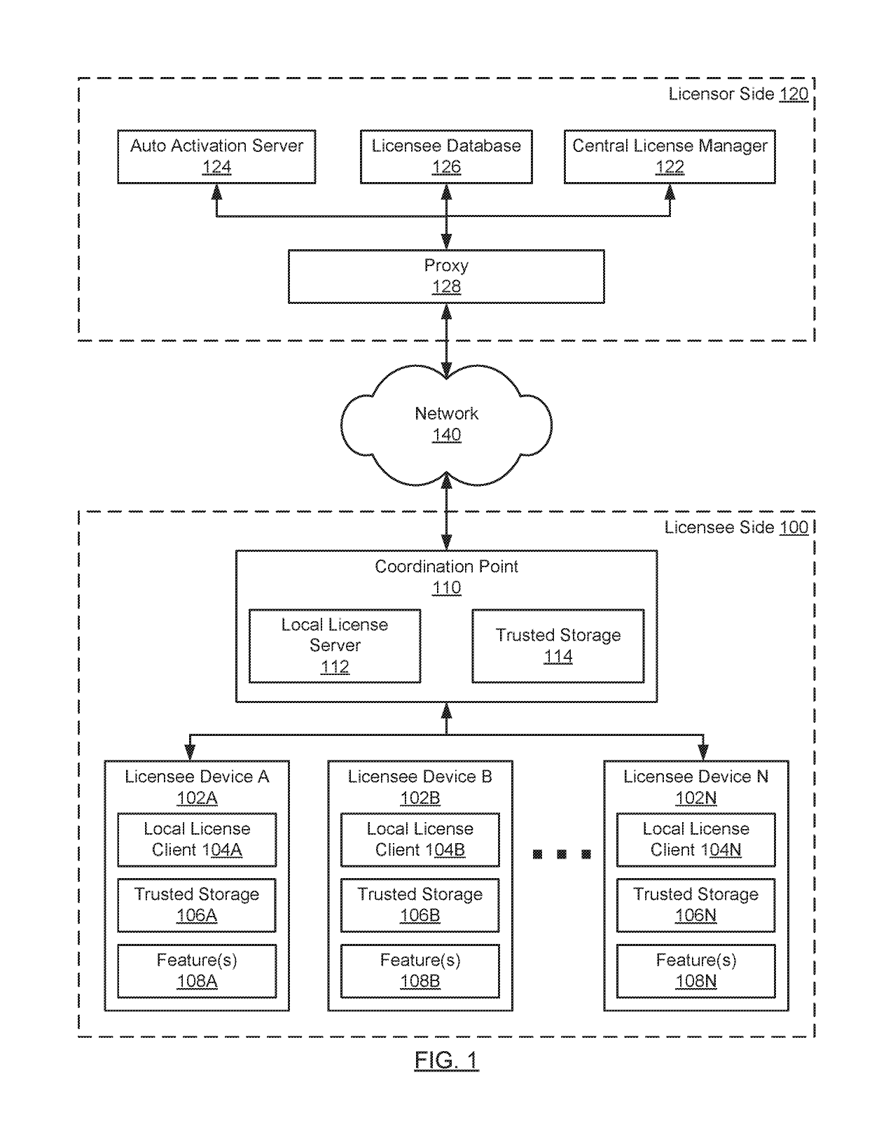

In the following description of FIGS. 1-7, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for license management. In one or more embodiments of the invention, licenses are automatically provisioned, thereby facilitating the administration of licenses. More specifically, embodiments of the invention may enable late binding of licenses, where licenses that have been purchased are not immediately assigned. Instead these licenses may be assigned at a later time, e.g. automatically, as needed.

FIG. 1 shows a system for license management. The system, in accordance with one or more embodiments of the invention, includes multiple components on a licensee side (100) and on a licensor side (120). The licensee side may be a legal entity, e.g., a corporation that licenses software and/or hardware. The licensor may be another legal entity, e.g., a corporation that provides the license for the software or hardware being licensed by the corporation on the licensee side (100). Further, additional parties may be involved. For example, the licensor may rely on third party software and/or hardware to administrate and enforce licensing.

The system, on the licensee side (100), in accordance with one or more embodiments of the invention, includes licensee devices (102A-102N), and one or more coordination points (110). The system, on the licensor side (120), in accordance with one or more embodiments of the invention, includes a central license manager (122), an auto activation server (124), a licensee database (126), and may further include a proxy (128). The components on the licensee side (100) and on the licensor side (120) may be operationally connected by a network (140), e.g., the Internet, a local area network or a dedicated connection. Each of the above components is further described below.

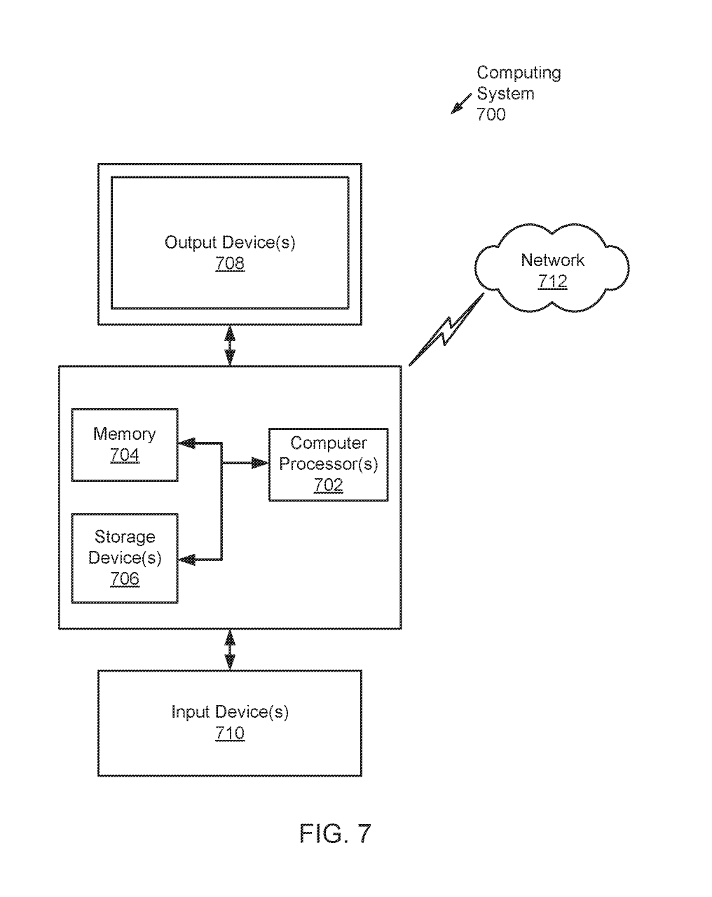

Turning to the licensee side (100), the licensee devices (102A-102N) may be computing devices (e.g., servers, desktop personal computers, laptop personal computers, tablet computers, etc.) such as the computing device described with reference to FIG. 7, network devices (e.g., routers, switches or multilayer switches) or any other types of devices that include one or more features (108A-108N) that require a license in order to be activated. A feature may be a hardware or software-based functionality. Any functionality or characteristic that requires a license in order to be activated may be a feature. For example, a feature in a network device may be an implementation of a particular network protocol (e.g., the border gateway protocol (BGP), a management interface, etc.) Those skilled in the art will appreciate that features (108A-108N) are not limited to the above examples.

In one embodiment of the invention, each of the licensee devices (102A-102N) includes a local license client (104A-104N). A local license client on a licensee device may be responsible for obtaining a feature license that permits activation and/or use of the feature(s) and for enforcing license terms such as the beginning of the license term, the end of the license term and device-specific limitations such as the limited use of a feature license in a particular configuration, on a particular hardware, etc. Further, if a feature license has an expiration date, the local license client may also be responsible for the renewal of the license, prior to expiration of the feature license. The local license clients (104A-104N) may be custom software services developed by the licensor, or alternatively, elements of the local license clients or the entire local license clients may be software services provided by a third party.

In one embodiment of the invention, each of the licensee devices (102A-102N) further includes trusted storage (106A-106N). The trusted storage may store received activated feature licenses and may protect activated feature licenses against unauthorized access. In one embodiment of the invention, only the local license client (104A-104N) and/or other license monitoring and enforcing components have access to the trusted storage (106A-106N), thus giving them exclusive authority over enabling and disabling features that require feature licenses. The trusted storage may include volatile and/or non-volatile memory such as, for example, random access memory (RAM), solid state memory and hard disk drives. The trusted storage may be encrypted to protect its content against unauthorized access. Further, content may be digitally signed to prevent tampering with the content.

The licensee devices (102A-102N), in accordance with an embodiment of the invention, are operatively connected to the coordination point (110). The licensee devices and the coordination point may communicate using any combination of wired and/or wireless communication protocols. The licensee devices and the coordination point may be connected via a local network (e.g., an Ethernet network) or via a wide area network (e.g., the Internet). The communication between the licensee devices and the coordination point may include any combination of secured (e.g., encrypted) and non-secured (e.g., un-encrypted) communication. The manner in which the licensee devices (102A-102N) and the coordination point (110) communicate may vary based on the implementation of the invention.

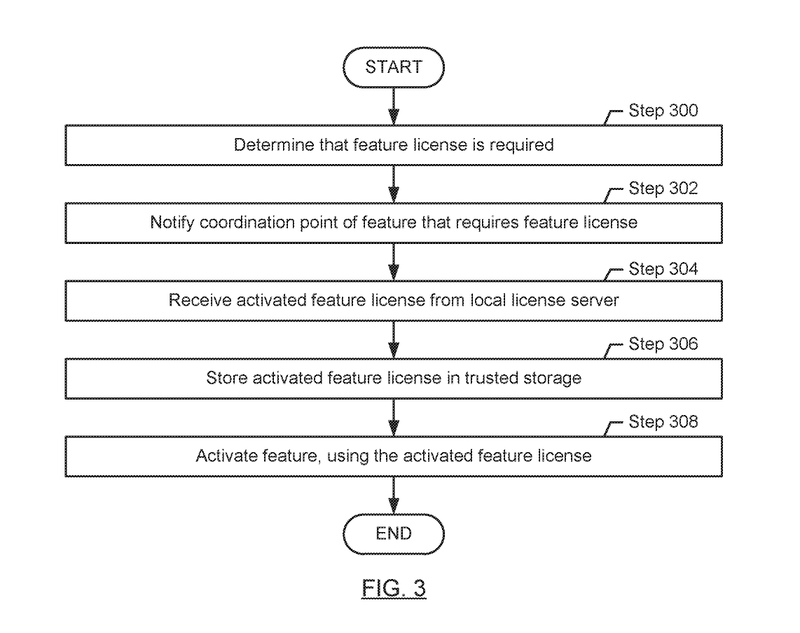

Continuing with the discussion of the components on the licensee side, the coordination point (110), in accordance with one or more embodiments of the invention, provides a mechanism to share information between and/or with the licensee devices (102A-102N). More specifically, the coordination point (110) may be used to obtain state information from one or more of the licensee devices, process the obtained state information, and take an appropriate action. In one or more embodiments of the invention, the states obtained from the licensee devices include information about features to be used or being used on the licensee devices. The coordination point (110), in accordance with an embodiment of the invention, upon discovery of a feature of a licensee device that requires a feature license, contributes to the acquisition of that feature license, as further described below with reference to FIGS. 3-6. In other words, the coordination point (110) may monitor the licensee devices (102A-102N) to determine the need for licenses and may obtain the needed licenses from the licensor.

The coordination point, in accordance with an embodiment of the invention, is a service that may execute on a dedicated or shared physical or virtual server. The coordination point may be hosted, for example, by a computing device similar to the one described in FIG. 7. Alternatively, the coordination point (110) may be hosted by one of the licensee devices (102A-102N). The coordination point may be hosted, for example, on a network router or switch. In one embodiment of the invention, multiple redundant coordination points (110) exist on the licensee side (100). One of the coordination points may be the active coordination point that performs one or more of the steps described below with reference to FIGS. 3-6, whereas the other coordination points may be backup coordination points that mirror the active coordination point, without actively contributing to the license service scheme described below. A backup coordination point may take over the role of the master coordination point if the master coordination point fails, thus providing continuous availability of the license services.

In one embodiment of the invention, the coordination point (110) includes a local license server (112). The local license server, in accordance with an embodiment of the invention, is configured to contact the central license manager (122) in order to obtain the appropriate type and number of activated feature licenses, as determined by the coordination point. The local license server, in accordance with an embodiment of the invention, is further configured to manage the acquired activated feature licenses, including providing the acquired activated feature licenses to the licensee devices. The local license server (112) may be a custom software service developed by the licensor, or alternatively, elements of the local license server or the entire local license server may be a software service provided by a third party.

In one embodiment of the invention, the coordination point further includes trusted storage (114). The trusted storage may store received activated feature licenses and may protect activated feature licenses against unauthorized access. In one embodiment of the invention, only the local license server (112) has access to the trusted storage (114), thus giving the local license server the exclusive control over providing activated feature licenses to the local license clients (104A-104N). The trusted storage may include volatile and/or non-volatile memory such as, for example, random access memory (RAM), solid state memory and hard disk drives. The trusted storage may be encrypted to protect its content against unauthorized access. Further, content may be digitally signed to prevent tampering with the content.

Turning to the licensor side (120), the central license manager (122), in accordance with an embodiment of the invention, provides a portal for obtaining and managing licenses for the licensee. For example, the portal may include a web page that system administrators of the corporation on the licensee side (100) may access to view license usage statistics, to manage the binding of licenses and/or to purchase licenses for the licensee devices (102A-102B). The central license manager may administrate the purchased licenses and may release the purchased licenses for use on the licensee devices, as described below in FIGS. 3-6. The central license manager (122) may be a custom software service developed by the licensor, or alternatively, elements of the central license manager or the entire central license manager may be a software service provided by a third party. The central license server may be hosted on a dedicated or shared physical or virtual server, for example, on a computing device similar to the computing device described in FIG. 7. Further, the central license manager may be distributed over multiple servers, e.g., for load balancing and/or redundancy.

Continuing with the discussion of the licensor side (120), the auto activation server (124), in accordance with an embodiment of the invention, provides an interface between the central license manager (122) and the coordination point (110). More specifically, the auto activation server (124) may automate the task of obtaining activated feature licenses from a pool of previously purchased feature licenses, administrated by the central license manager, upon request by the coordination point (110). The interaction of the auto activation server (124) with the coordination point (110), the central license manager (122) and other components of the system may thus establish a substitute for manually assessing, e.g., by a system administrator, feature license requirements, for manually requesting the licenses from the central license manager (122), and for manually installing the requested licenses on the licensee devices.

In one embodiment of the invention, the auto activation server (124) is a service that may execute on a dedicated or shared physical or virtual server. The auto activation server may be hosted, for example, by a computing device similar to the one described in FIG. 7. In one embodiment of the invention, the auto activation server is a Python web application, based on the web server gateway interface (WSGI) specification, and executing behind a reverse proxy, further described below.

The system, on the licensor side, further includes a licensee database (126), in accordance with an embodiment of the invention. The licensee database may include credentials of licensees. The credentials may include, but are not limited to, customer IDs (e.g., a corporation's name, an administrator account name, or an arbitrarily selected string) and passwords. The auto activation server (124) may refer to the licensee database (126) in order to validate requests, such as requests for records of available feature licenses, from the coordination point (110). The auto activation server may process the request only if the credentials provided along with the request match the credentials in the licensee database (126).

In one embodiment of the invention, the licensee database (126) is a lightweight directory access protocol (LDAP) server. Alternatively, any other type of database may be used to store licensee credentials. The licensee database may be, for example, a list, a spreadsheet or any other type of database suitable for storing credentials.

In one embodiment of the invention, the system, on the licensor side, further includes a proxy. The proxy (128), in accordance with an embodiment of the invention is a reverse proxy server that forwards requests, e.g., from the coordination point (110), to the auto activation server (124) and/or to the central license manager (122). The proxy may be used, for example, for protocol translation, e.g. to secure communications from/to the local license server (104), to rewrite uniform resource locators (URLs), to compress/decompress data being sent/received, for load balancing and/or as a protection against distributed denial of service (DDoS) attacks.

The central license manager (122), the auto activation server (124), the licensee database (126), and the proxy (128) may be connected via a local network (e.g., an Ethernet network) or via a wide area network (e.g., the Internet). The communication between the central license manager, the auto activation server, the licensee database, and the proxy may include any combination of secured (e.g., encrypted) and non-secured (e.g., un-encrypted) communication. The manner in which the central license manager, the auto activation server, the licensee database, and the proxy communicate may vary based on the implementation of the invention. For example, all communications may be encrypted in scenarios in which one or more of the servers on the licensor side are cloud-based, whereas some communications may not be encrypted if the servers are located in an isolated, protected local area network.

One skilled in the art will recognize that the architecture of a system for license management is not limited to the components shown in FIG. 1. For example, the system may have any number of licensee devices. Further, multiple coordination points may exist to provide redundancy. In addition, some of the services shown as discrete components in FIG. 1 may be co-hosted on a single computing device. For example, the auto activation server, the licensee database and/or the central license manager may be co-hosted. Similarly, the coordination point may be hosted by one of the licensee devices, without departing from the invention.

In one or more embodiments of the invention, sensitive data such as activated feature licenses, credentials, etc. may be exchanged between different services. To protect these data against unauthorized access, communications between the components of the system may rely on cryptographically secured protocols such as, for example, transport layer security (TLS) and secure sockets layer (SSL). Further to prevent tampering with exchanged data, the exchanged data may be cryptographically signed.

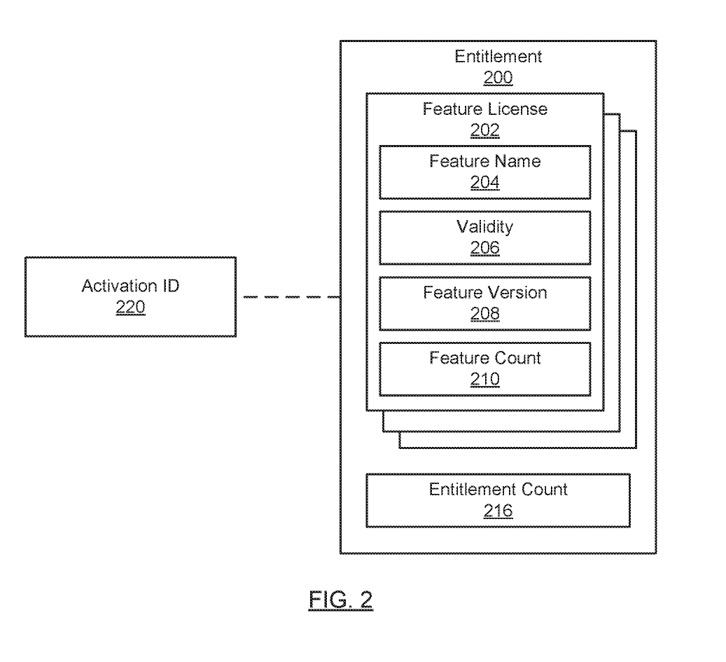

FIG. 2 shows an entitlement and a corresponding activation identifier (ID), in accordance with one or more embodiments of the invention. The entitlement (200) includes one or more feature licenses (202). A feature license, in accordance with an embodiment of the invention, is a basic licensable unit. A feature license may be used, for example, to activate a particular hardware or software-based functionality. One or more attributes may be associated with a feature license. These attributes may include, but are not limited to a feature name (e.g. an alphanumeric descriptor) (204), a validity (206), a feature version (208) and a feature count (210). The validity (206) may specify a time interval during which the feature is available under a granted feature license. The time interval may be specified using a license term beginning and/or a license term end. For example, an active feature license may be configured to be valid for a limited duration only, e.g., for ten hours. The license may thus require periodic renewal if it is to be used over a prolonged time. The validity may also be device specific, for example, the validity may be limited to a particular group of hardware, a particular hardware device, a particular serial number, a particular media access control (MAC) address, etc. The feature version (208) may specify what version (e.g. if there are different releases of different scope or date) is licensed. The feature count (210) may specify how many features of a particular type are licensed as part of the entitlement (200). The entitlement may further include an entitlement counter (216) that specifies how many times the set of features in an entitlement is licensed.

In one embodiment of the invention, an entitlement (200) has a corresponding activation ID (220). The activation ID, in accordance with an embodiment of the invention, is a unique alphanumeric string that may be used to uniquely identify an entitlement and the set of features in the entitlement. An activation ID may be assigned by the central license manager after a set of features (or a single feature) is purchased in the form of feature license(s), ordered by a customer.

FIGS. 3-6 show flowcharts in accordance with one or more embodiments of the invention. The flowcharts describe methods for license management and for automated distribution of feature licenses to licensee devices. Each of the flowcharts represents contributions of a particular component of the system for license management, as these components are interacting, in accordance with one or more embodiments of the invention. Prior to the execution of the methods described in FIGS. 3-6, a relationship between the licensor and the licensee may have been established. As a result, licensee information may be stored in the licensee database. This information may include credentials such as a licensee name, e.g. the name of a company, or a user name, and a password, associated with the licensee name. Further, one or more entitlements that include the feature licenses and corresponding activation IDs have been generated and are stored on the central license manager. More specifically, the central license manager may have obtained order data including customer account information, order specifics (including quantities and expiration dates of the licenses being ordered, etc.). Upon receipt of the license order, the central license manager may have generated one or more entitlements and the corresponding activation ID(s), based on the order. The entitlement(s), in accordance with an embodiment of the invention, include(s) the feature license(s), ordered by the customer. The feature license(s) in the entitlement(s) are accompanied by attributes (e.g., validity, feature counts, etc.), as specified in the customer order.

While the various steps in the flowcharts are presented and described sequentially, one of ordinary skill will appreciate that some or all of these steps may be executed in different orders, may be combined or omitted, and some or all of the steps may be executed in parallel. In one embodiment of the invention, the steps shown in FIGS. 3-6 may be performed in parallel with any other steps shown in FIGS. 3-6 without departing from the invention.

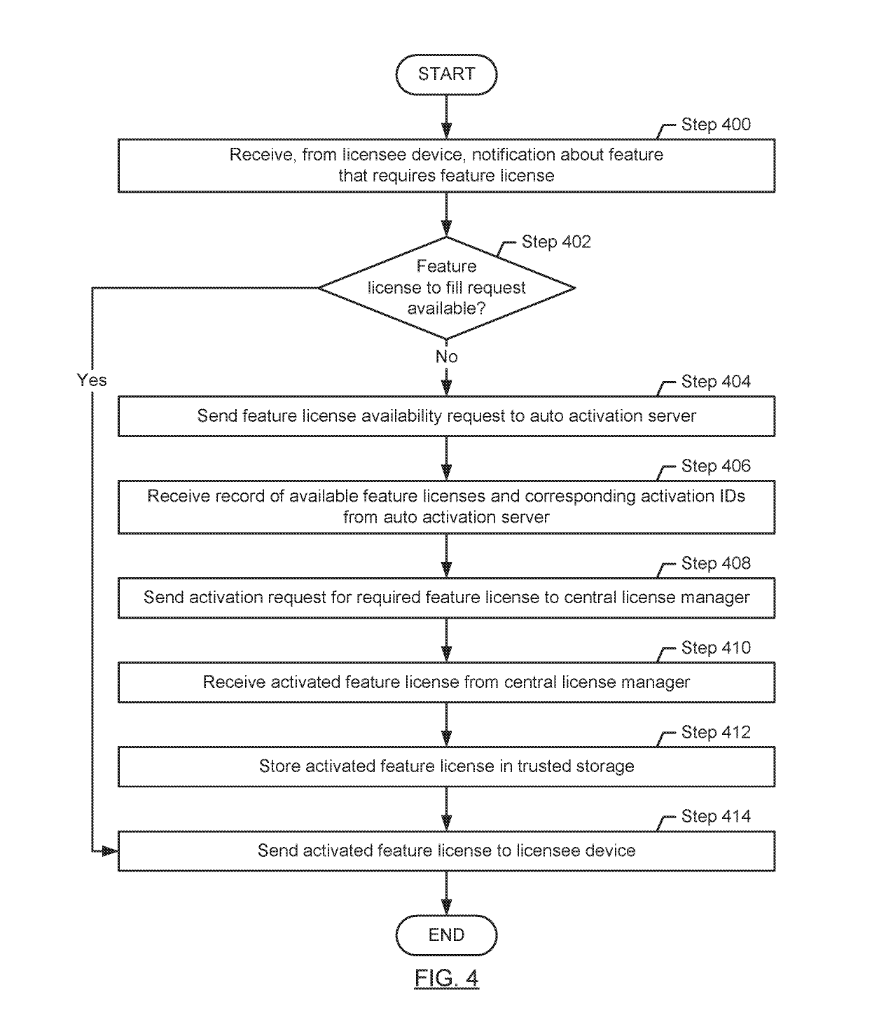

FIG. 3 shows steps of a method for license management, performed by a licensee device. The steps may be performed during interactions with a coordination point. The method described in FIG. 3 may be executed upon occurrence of an event that requires a feature license. The execution of the method involves interaction with other components of the system for license management and thus engages these components as further described with reference to FIGS. 4-6.

In Step 300, a determination is made that a feature license is required by the licensee device. A feature license may be required because a feature requiring the feature license is activated, and the local license client of the licensee device is unable to provide the license, for example, because it is not in possession of the required license. The feature that requires a license may be a software and/or hardware-based feature that is newly activated. Alternatively, the feature may be an already activated feature for which a license renewal is necessary because the current feature license is about to expire.

In Step 302, the licensee device notifies the coordination point of the need for a feature license. In one embodiment of the invention, the licensee devices report state changes to the coordination point. One of the state changes may indicate the desired activation of a feature that requires a feature license. Subsequently, the licensee device may wait to receive an activated feature license from the local license server of the coordination point.

In Step 304, an activated feature license is received from the local license server of the coordination point. The active feature license may be delivered as a binary file that may include license attributes such as the validity (e.g., specifying an expiration date) and other limitations. In one embodiment of the invention, the active feature license, provided by the local license server, is delivered to the local license client of the coordination point. The file used to deliver the active feature license may be cryptographically protected (e.g. using a private/public key pair) such that only the local license server can access the license. Further, the file may be digitally signed to prevent tampering with active feature license.

In Step 306, the active feature license is stored in the trusted storage of the licensee device.

In Step 308, the local license client, having received the active feature license, allows activation of the feature for which the feature license was requested in Step 302.

FIG. 4 shows steps of a method for license management, performed by the coordination point. The steps may be performed during interactions with the licensee device, the auto activation server and/or the central license server.

In Step 400, the coordination point receives the notification about the required feature license, sent by the licensee device in Step 302.

In Step 402, a determination is made about whether a feature license to fill the request is available. A feature license may be available if it had been requested earlier. In such a case, the local license server may possess the license. If a determination is made that a feature license is available, the method may proceed to Step 414, in which the local license server of the coordination point may send the activated feature license to the licensee device. If a determination is made that no feature license is available to fill the request, the method may proceed to Step 404.

In Step 404, the coordination point sends a feature license availability request to the auto activation server. The request, in accordance with an embodiment of the invention, is sent to the auto activation server to determine what types of licenses and what quantities of licenses are available. The request may be an HTTP “GET” request. The request may include credentials that enable the auto activation server to authenticate the requestor. These credentials may be, for example, a combination of a user name and a password or any other credential that enables the auto activation server to verify the identity of the coordination point. If an HTTP “GET” request is used, user name and password may be included in a basic authentication header of the request. In one embodiment of the invention, the request is encrypted using a secure protocol, e.g., the transport layer security (TLS) protocol. Subsequently, the coordination point may wait for a response from the auto activation server.

In Step 406, a record of available feature licenses and corresponding activation IDs is received from the auto activation server. The record may include some or all of the available feature licenses. Available feature licenses may be licenses that have been purchased, but that are not already in use.

In Step 408, upon receipt of the record of available feature licenses in Step 406, the local license server sends an activation request for the required feature license, requested by the licensee device in Step 302, to the central license manager. The request, in accordance with an embodiment of the invention, uses the activation ID to specify the desired feature license to be activated. The activation ID may be selected from the activation IDs received in Step 406. The request may further include a customer ID that uniquely identifies the licensee. The request may, also include a quantity of required licenses to be activated, if multiple licenses are to be activated. The request may be sent using cryptographically secured protocols such as, for example, transport layer security (TLS) or secure sockets layer (SSL). Further to prevent tampering, the request may be cryptographically signed. Subsequently, the local license server may wait for a response from the central license manager.

In Step 410, the local license server receives the activated feature license from the central license manager. As previously noted, the activated feature license may be delivered as a binary file that may include license attributes such as the validity (e.g., specifying an expiration date) and other limitations.

In Step 412, the active feature license is stored in the trusted storage of the local license server.

In Step 414, the local license server sends the activated feature license to the local license client of the licensee device.

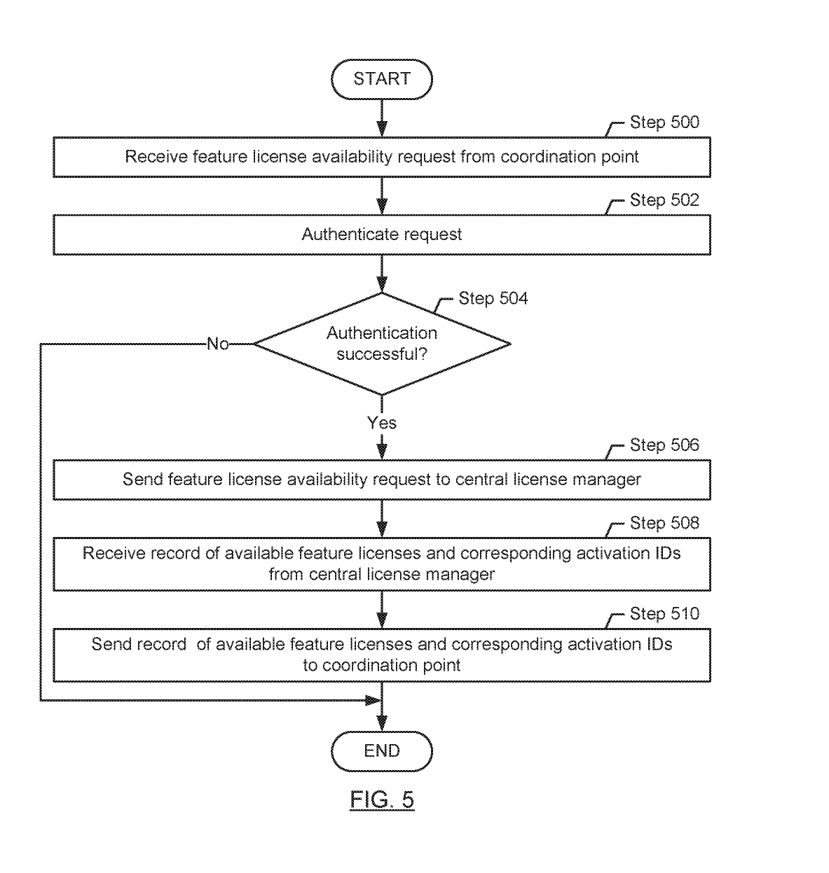

FIG. 5 shows steps of a method for license management, performed by the auto activation server. The steps may be performed during interactions with the coordination point, the licensee database, and/or the central license manager.

In Step 500, the auto activation server receives the feature license availability request from the coordination point. If a proxy server is used, the auto activation server may receive the request indirectly, via the proxy. The request, forwarded by the proxy, may use the web server gateway interface (WSGI) protocol. As previously noted, the request includes credentials that are specific to the customer that operates the coordination point.

In Step 502, the auto activation server, in accordance with an embodiment of the invention, authenticates the coordination point based on the credentials included in the feature license availability request. The credentials may be, for example, a username and a password. The auto activation server, in accordance with an embodiment of the invention, contacts the licensee database to validate the received credentials. If the licensee database is a lightweight directory access protocol (LDAP) server, the auto activation server may use an LDAP “bind” request to validate the credentials. Transport layer security (TLS) encryption may be used to secure the connection between the auto activation server and the licensee database.

In Step 504, a determination is made about whether the authentication in Step 502 was successful. If the authentication was unsuccessful, e.g., because the username/password combination provided by the coordination point does not match any of the credential entries in the licensee database, the execution of the method terminates. The auto activation server may return a message (e.g., in the form of a JavaScript Object Notation (JSON) object) to the coordination point, indicating that the user name and/or password is invalid. In this case, the execution of the methods described in FIGS. 3-6 does not complete, and the licensee device may therefore not receive an activated feature license. If a determination is made that the authentication was successful, the method may proceed to Step 506.

In Step 506, the auto activation server sends a feature license availability request to the central license manager. The request, in accordance with an embodiment of the invention, includes credentials (e.g., user name and password) specific to the central license manager. The request is stated using a protocol accepted by the central license manager. In one embodiment of the invention, the simple object access protocol (SOAP) over Hypertext Transfer Protocol (HTTP) or HTTP Secure (HTTPS) is used. Subsequently, the auto activation server may wait for a response from the central license manager.

In Step 508, the auto activation server receives a record of available feature licenses and corresponding activation IDs from the central license manager. The record of available feature licenses may include licenses that have been purchased, but that have not yet been activated. Licenses may be organized by entitlements, as previously described, and may be accompanied by corresponding unique activation IDs. The record of available feature licenses may include a comprehensive list of all available licenses, regardless of the licenses type, or alternatively the record may include only certain types of licenses. The record of available feature licenses may be based on the simple object access protocol (SOAP) format, enabling the exchange of the available feature licenses using, e.g., the hypertext transfer protocol (HTTP).

In Step 510, the auto activation server sends the record of available feature licenses and corresponding activation IDs to the coordination point. In one embodiment of the invention, the record of available feature licenses is packaged in a JSON object. If an error occurred during the retrieval of the record of available feature licenses from the central license manager, the auto activation server may instead return an error message to the coordination point.

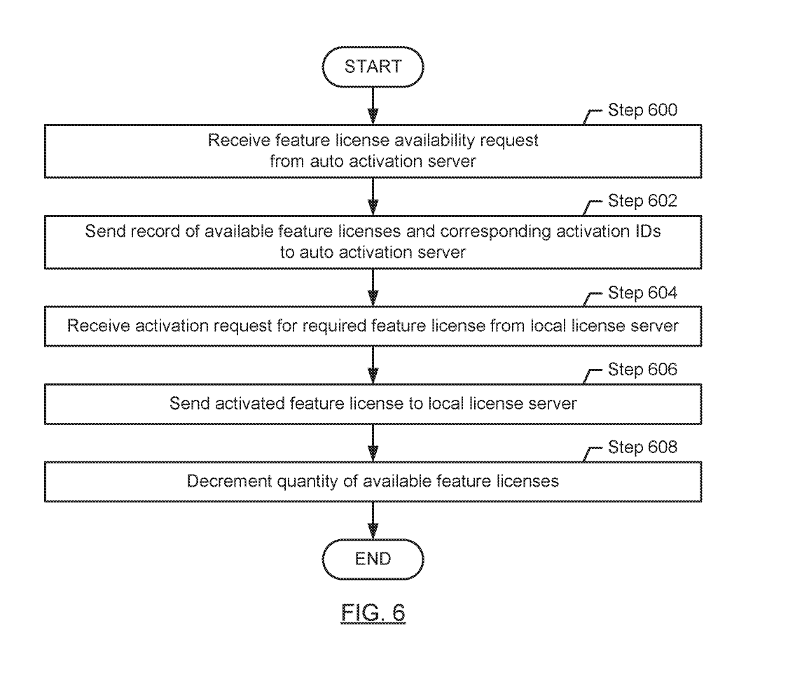

FIG. 6 shows steps of a method for license management, performed by the central license manager. The steps may be performed during interactions with the auto activation server and/or the local license server.

In Step 600, the central license manager receives the feature license availability request from the auto activation server. The central license manager, upon receipt of the request, may validate the credentials included in the request, prior to accepting the request.

In Step 602, the central license manager sends a record of available feature licenses and corresponding activation IDs to the auto activation server. The license server, in accordance with an embodiment of the invention, keeps track of the feature licenses a client has purchased and of whether the feature licenses have been activated. Only purchased feature licenses that have not been activated may be reported in Step 602.

In Step 604, the central license manager receives an activation request for a required feature license from the local license server. The activation request, in accordance with an embodiment of the invention, includes an activation ID and a quantity of requested licenses, based on which the central license manager may determine the type and number of licenses that are requested by the local license server. The central license manager may further identify the licensee based on a customer ID that may also be included in the request.

In Step 606, the central license manager generates the activated feature license and sends the activated feature license to the local license server. The activated feature license file may be a binary file that includes information such as the type of feature that is being licensed, the number of licenses granted, validity limitations such as an expiration date, etc. As previously noted, the central license server may apply cryptographic protection to ensure that no unauthorized changes are made to the activated feature license.

In Step 608, the central license server decrements the quantity of available feature licenses to account for the activated feature licenses which are therefore no longer available for distribution.

While the above steps describe the obtaining of a feature license, required in order to activate a feature, those skilled in the art will recognize that a feature license that is no longer be required may eventually be returned. Specifically, the local license client may return a feature license to the local license server by requesting zero licenses of the previously requested feature license type. Further, the central license manager may revoke the feature license provided to the local license server, e.g., in response to a request made by a system administrator. The local license server may discover that the feature license is no longer available from the central license manager, once the local license server communicates with the central license manager to check and synchronize license information. As a result, the local license server may no longer provide the feature license to the local license client, and consequentially the feature requiring the feature license may become unavailable on the licensee device.

Example Use Case

The use case scenario described below is intended to provide an example of the method for license management, described in FIGS. 3-6, and is for illustrative purposes only. The use case scenario is based on a system similar to the one shown in FIG. 1, where the licensee devices (102A-102N) are network devices such as routers, switches and/or multilayer switches. The functionalities to be licensed are network device functionalities that include enhanced layer 3 functionalities (e.g., the border gateway protocol (BGP)), virtualization (e.g., to support Virtual Extensible LAN (VXLAN)), monitoring and provisioning tools, etc. The method described by FIGS. 3-6 is limited to neither the system shown in FIG. 1, nor to the use case scenario described below, but rather is universally applicable to a wide range of systems of different configuration, complexity and size.

Consider a scenario in which two network devices (102A, 102B) are added to an existing system. Network device A (102A) is a switch that replaces a defective switch, and network device B (102B) is a newly added router. Each of the network devices require a feature license for monitoring and provisioning, whereas only the router requires a feature license for enhanced layer 3 features. As the network devices (102A, 102B) are booted, the coordination point becomes aware of them and their license requirements. The local license server has one available activated feature license for “monitoring and provisioning” that was previously assigned to the defective switch that was replaced by the new switch (102A). Accordingly, the active feature license for “monitoring and provisioning” is assigned to the new switch, thus meeting all licensing requirements of the switch. The local license server, however, possesses neither a second “monitoring and provisioning” activated feature license, nor an “enhanced layer 3” activated feature license.

The coordination point therefore contacts the auto activation server to determine whether these licenses have been purchased, such that the central license manager can provide these licenses. The auto activation server confirms with the central license server that these feature licenses are available and returns a feature license report that also includes the activation IDs that identify the desired licenses.

Having determined the activation IDs corresponding to the “monitoring and provisioning” features, the local license server sends an activation request for one “monitoring and provisioning” feature license and for one “enhanced layer 3” license to the central license manager. The central license manager responds by returning the activated “monitoring and provisioning” feature license and the activated “enhanced layer 3” license to the local license server. The local license server forwards both licenses to the local license client of the new router (102B), thus enabling activation of the “monitoring and provisioning” and “enhanced layer 3” features on the router.

Embodiments of the invention may enable feature licenses to be automatically obtained, as needed. Even in a system with a large number of licensee devices, licensing may be performed with a minimum of system administrator involvement. Rather than having to assess feature license requirements for individual licensee devices and having to install licenses on these individual licensee devices, the system administrator may focus on strategic choices such as what licenses to purchase, and how the purchased licenses are to be distributed. Embodiments of the invention may thus facilitate the management of feature licenses used to control access to hardware and/or software features. Embodiments of the invention may further enable the enforcement of compliance with licensing requirements. For example, embodiments of the invention enable a licensor to assess the types and quantity of licenses that the licensee's system requires. The license provider may strictly limit the licenses provided to the licensee to the license that were purchased. Any requests for additional activated feature licenses, beyond the purchased licenses, may thus be denied. Alternatively, the licensor may issue “overdraft” licenses that allow features to be activated even though an appropriate license has not been acquired by the licensee. These overdraft licenses may issue a warning to the licensee and/or to the licensor, may be temporarily valid only, and/or may be limited in quantity.

Embodiments of the invention may be implemented on a computing system. Any combination of mobile, desktop, server, embedded, or other types of hardware may be used. For example, as shown in FIG. 7, the computing system (700) may include one or more computer processor(s) (702), associated memory (704) (e.g., random access memory (RAM), cache memory, flash memory, etc.), one or more storage device(s) (706) (e.g., a hard disk, an optical drive such as a compact disk (CD) drive or digital versatile disk (DVD) drive, a flash memory stick, etc.), and numerous other elements and functionalities. The computer processor(s) (702) may be an integrated circuit for processing instructions. For example, the computer processor(s) may be one or more cores, or micro-cores of a processor. The computing system (700) may also include one or more input device(s) (710), such as a touchscreen, keyboard, mouse, microphone, touchpad, electronic pen, or any other type of input device. Further, the computing system (700) may include one or more output device(s) (708), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (700) may be connected to a network (712) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform embodiments of the invention.

Further, one or more elements of the aforementioned computing system (700) may be located at a remote location and connected to the other elements over a network (712). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for license management, the method comprising:
making a first determination by a local license server of a coordination point that a feature license is required by the local license server, wherein the feature license is not available on the local license server;
based on the first determination:
sending, by the coordination point, a license availability request to an auto activation server;
receiving, by the coordination point and from the auto activation server, information about a plurality of available feature licenses;
sending, by the local license server of the coordination point to a central license manager, an activation request specifying the feature license, wherein the feature license is one of the plurality of available feature licenses; and
in response to sending the activation request: receiving, by the local license server from the central license manager, an activated feature license.

2. The method of claim 1, further comprising, prior to making the first determination:
receiving, from a licensee device, by the coordination point, a notification that the feature license is required by the licensee device.

3. The method of claim 2,
wherein the notification comprises a state update indicating that a feature has been activated on the licensee device; and
wherein the coordination point determines that the activation of the feature requires the feature license.

4. The method of claim 2, further comprising, after receiving the activated feature license by the local license server:
providing, by the local license server, the activated feature license to the licensee device.

5. The method of claim 2, further comprising:
making a second determination by the local license server of the coordination point that a second feature license is required, wherein the second feature license is present on the local license server; and
based on the second determination:
providing, by the local license server, a second activated feature license to the licensee device.

6. The method of claim 1, wherein activated feature license specifies license terms.

7. The method of claim 6, wherein the license terms comprise at least one selected from a group consisting of a license term beginning, a license term end and a device-specific limitation.

8. The method of claim 1, further comprising, after having received, by the local license server, the activated feature license:
storing the activated feature license in a protected storage.

9. The method of claim 1,
wherein available feature licenses are identified by activation IDs corresponding to the available feature licenses; and
wherein the activation request, sent to the central license manager, by the local license server, comprises an activation ID corresponding to the feature license.

10. A method for license management, the method comprising:
receiving, by an auto activation server, a license availability request from a coordination point;
determining available feature licenses, in response to the license availability request, comprising:
querying, by the auto activation server, a central license manager for available feature licenses;
receiving, from the central license manager, information specifying available feature licenses and corresponding activation IDs; and
sending, by the auto activation server, the information specifying the available feature licenses and corresponding activation IDs to the coordination point.

11. A system for license management, the system comprising:
a coordination point comprising a local license server;
a central license manager; and
an auto activation server,
wherein the coordination point is configured to:
make a first determination, by the local license server, that a feature license is required by the local license server, wherein the feature license is not available on the local license server;
based on the first determination:
send a license availability request to the auto activation server;
receive, from the auto activation server, information about a plurality of available feature licenses;
send, by the local license server to the central license manager, an activation request specifying the feature license, wherein the feature license is one of the plurality of available feature licenses; and
in response to sending the activation request: receive, by the local license server from the central license manager, an activated feature license.

12. The system of claim 11, wherein the coordination point is further configured to:
prior to making the first determination:
receive, from a licensee device, a notification that the feature license is required by the licensee device; and
after receiving the activated feature license by the local license server:
provide, by the local license server, the activated feature license to the licensee device.

13. The system of claim 12, wherein the coordination point is further configured to:
make a second determination by the local license server that a second feature license is required, wherein the second feature license is present on the local license server; and
based on the second determination:
provide, by the local license server, a second activated feature license to the licensee device.

14. The system of claim 11,
wherein available feature licenses are identified by activation IDs corresponding to the available feature licenses; and
wherein the activation request, sent to the central license manager, by the local license server, comprises an activation ID corresponding to the feature license.

15. A system for license management, the system comprising:
a coordination point comprising a local license server;
a central license manager; and
an auto activation server,
wherein the auto activation server is configured to:
receive a license availability request from a coordination point;
determine available feature licenses, in response to the license availability request, comprising:
querying the central license manager for available feature licenses;
receiving, from the central license manager, information specifying available feature licenses and corresponding activation IDs; and
sending the information specifying the available feature licenses and corresponding activation IDs to the coordination point.

16. A non-transitory computer readable medium (CRM) comprising instructions that enable a coordination point to:
make a first determination by a local license server of the coordination point that a feature license is required by the local license server, wherein the feature license is not available on the local license server;
based on the first determination:
send a license availability request to an auto activation server;
receive from the auto activation server, information about a plurality of available feature licenses;
send, by the local license server of the coordination point to a central license manager, an activation request specifying the feature license, wherein the feature license is one of the plurality of available feature licenses; and
in response to sending the activation request: receive, by the local license server from the central license manager, an activated feature license.

17. The non-transitory CRM of claim 16, further comprising instructions that enable the coordination point to:
prior to making the first determination:
receive, from a licensee device, a notification that the feature license is required by the licensee device; and
after receiving the activated feature license by the local license server:
provide, by the local license server, the activated feature license to the licensee device.

18. The non-transitory CRM of claim 17, further comprising instructions that enable the coordination point to:
make a second determination by the local license server of the coordination point that a second feature license is required, wherein the second feature license is present on the local license server; and
based on the second determination:
provide, by the local license server, a second activated feature license to the licensee device.

19. The non-transitory CRM of claim 16,
wherein available feature licenses are identified by activation IDs corresponding to the available feature licenses; and
wherein the activation request, sent to the central license manager, by the local license server, comprises an activation ID corresponding to the feature license.

20. A non-transitory computer readable medium comprising instructions that enable an auto activation server to:
receive a license availability request from a coordination point;
determine available feature licenses, in response to the license availability request, comprising:
querying a central license manager for available feature licenses;
receiving, from the central license manager, information specifying available feature licenses and corresponding activation IDs; and
send the information specifying the available feature licenses and corresponding activation IDs to the coordination point.
